(19) United States
(12) Patent Application Publication
(10) Pub. No.: US 2026/0148913 A1
(43) Pub. Date: May 28, 2026

(54) SWITCHING DEVICE FOR A MEDIUM-VOLTAGE ELECTRIC UNIT

(71) Applicant: Schneider Electric Industries SAS, Rueil-Malmaison (FR)

(72) Inventor: Dominique Treffot, Rueil-Malmaison (FR)

(73) Assignee: Schneider Electric Industries SAS, Rueil-Malmaison (FR)

(21) Appl. No.: 19/395,202

(22) Filed: Nov. 20, 2025

(30) Foreign Application Priority Data
Nov. 27, 2024 (EP) 24306980.4

(51) Int. Cl. H01H 33/04

(52) U.S. Cl. CPC H01H 33/04

(57) ABSTRACT

A switching device for a medium-voltage electric unit is proposed, having: a fixed contact, a mobile contact configured to pivot with respect to a pivot axis between: a first position in which the contacts are separated, and a second position in which the contacts are in contact, wherein the fixed contact comprises an electric arc guide projecting from the fixed contact, the electric arc guide being configured to be followed by an electric arc generated upon the establishment or the switching of the electric current between the fixed contact and the mobile contact, wherein the electric arc guide comprises two grooves separated by a rib.

### CROSS-REFERENCE TO RELATED APPLICATIONS

This application claims priority to and the benefit of European Patent Application No. 24306980.4, filed on Nov. 27, 2024, entitled “SWITCHING DEVICE FOR A MEDIUM-VOLTAGE ELECTRIC UNIT.”

### TECHNICAL FIELD

The present disclosure relates to the field of medium-voltage or high-voltage electric units, i.e. a voltage range from 1 kV to more than 52 kV. These units can be placed inside an insulating enclosure filled with a pressurized gas to improve the electrical insulation properties and to avoid unwanted electric arcing inside the insulating enclosure.

### BACKGROUND

Some electric units, for example circuit breakers, comprise a switching device for each phase of the electric network, alternately allowing the electric current flow to be established and the electric current flow to be interrupted. These switching devices comprise a mobile contact, for example a rotating contact, which can come into contact with a fixed contact to establish the electric current. The mobile contact can also be separated from the fixed contact in order to interrupt the flow of current.

During both the establishment of the electric current and the interruption of the electric current, an electric arc can form between the fixed contact and the mobile contact when said contacts are at a short distance from one another. This electric arc causes intense heating of the contacts, particularly if the current is established on a short circuit. This heating can cause the contacts to melt partially and can damage them. Repeated contact damage during the current establishment phases can disable the switching device.

The present disclosure aims to provide a solution to improve the reliability of medium-voltage switching devices.

### SUMMARY

For this purpose, the disclosure describes a switching device for a medium-voltage electric unit, having: a fixed contact comprising an electric conductor, a mobile contact comprising two electric conductors extending parallel to one another and at a distance from one other, the mobile contact being configured to pivot with respect to a pivot axis between: a first position in which the mobile contact is separated from the fixed contact in order to prevent the flow of electric current between the contacts, and a second position in which the mobile contact is in contact with the fixed contact in order to allow the flow of electric between the contacts, wherein the fixed contact comprises an electric arc guide projecting from the electric conductor of the fixed contact and directed towards the mobile contact, the electric arc guide being configured to be followed by an electric arc generated upon the establishment of the electric current between the fixed contact, wherein the electric arc guide comprises two grooves separated by a rib.

An electric arc generated by bringing two electric contacts at different electric potentials close to one another passes through the electric arc guide. The electric arc guide thus limits the heating of the fixed contact and the mobile contact, and reduces the risk of damage to these contacts. The reliability of the switching device is improved.

The characteristics listed in the following paragraphs can be implemented independently from one another or in all technically possible combinations:

A movement of the mobile contact from the first position, referred to as the open position, to the second position, referred to as the closed position, corresponds to a phase of establishment of the electric current in the switching device.

A movement of the mobile contact from the second position, referred to as the open position, to the second position, referred to as the closed position, corresponds to a phase of interruption of the electric current in the switching device.

The electric arc guide is configured to provide a route for an electric arc. In other words, an electric arc generated when the electric current is established passes through the electric arc guide.

The two electric conductors of the mobile contact are rotationally connected about a common axis of rotation.

The two electric conductors of the mobile contact are made of copper.

The electric conductor of the fixed contact is made of copper.

The electric arc guide is made of extra-hard steel, for example steel with a carbon content of between 1% and 2%. Alternatively, any other metal having good resistance to high temperatures, significantly greater than that of copper, can be used.

According to one embodiment of the switching device, the grooves extend parallel to one another, in a direction parallel to the pivot axis of the mobile contact.

The depth of a groove can be greater than the width of the rib.

According to one embodiment, the base of the grooves has a semicircular profile.

According to one aspect of the switching device, the mobile contact extends in a main direction perpendicular to the pivot axis.

According to one embodiment of the switching device, the mobile contact comprises a first reinforcement element, the first reinforcement element comprising a first portion supported on the first electric conductor of the mobile contact and a second portion extending perpendicular to the first portion in the direction of the second electric conductor of the mobile contact, wherein a lateral edge of the second portion of the first reinforcement element extends parallel to the axis of rotation of the mobile contact.

An electric arc generated by the establishment of the electric current between the fixed contact and the mobile contact passes from the lateral edge of the first reinforcement element to the rib of the electric arc guide.

The lateral edge of the second portion of the first reinforcement element is at a distance from the end of the electric conductor opposite the axis of rotation.

The first reinforcement element comprises, for example, a plate.

The first reinforcement element is metallic.

The first reinforcement plate is formed by a folded metal strip.

The first reinforcement plate is, for example, made of steel.

The first reinforcement plate has a U-shaped profile.

According to one aspect of the switching device, the lateral edge of the second portion of the first reinforcement element is successively opposite a first groove, the rib, and then a second groove when the mobile contact passes from the first position to the second position.

A minimum distance between the rib and the lateral edge of the second portion of the first reinforcement element is less than 3.0 millimeters.

This distance enables the electric arc to be initiated in a controlled manner between the mobile contact and the electric arc guide, at least part of the electric arc passing through the lateral edge of the second portion of the first reinforcement element.

According to one embodiment of the switching device, the mobile contact comprises a second reinforcement element, the second reinforcement element comprising a first portion supported on the second electric conductor of the mobile contact and a second portion extending perpendicular to the first portion in the direction of the first electric conductor of the mobile contact, wherein a lateral edge of the second portion of the second reinforcement element extends parallel to the axis of rotation of the mobile contact.

According to one embodiment, the lateral edge of the second portion of the first reinforcement element and the lateral edge of the second portion of the second reinforcement element extend in line with one another.

The second reinforcement element comprises, for example, a plate.

According to one aspect of the switching device, the lateral edge of the second portion of the second reinforcement element is successively opposite the first groove, the rib, and then the second groove when the mobile contact passes from the first position to the second position.

A minimum distance between the rib and the lateral edge of the second portion of the second reinforcement element is less than 3.0 millimeters.

This distance allows the electric arc to be initiated in a controlled manner between the mobile contact and the electric arc guide.

The first reinforcement plate and the second reinforcement plate are the mirror image of one another.

According to one aspect of the switching device, the electric conductor of the fixed contact comprises two contact portions in mechanical contact with the mobile contact when the mobile contact is in the second position, referred to as the closed position, and the electric arc guide is at a distance from the two contact portions.

The heating generated by the passage of the electric arc thus occurs in a part of the fixed contact which differs from the portions through which the electric current passes in a steady state. Damage to the fixed contact areas involved in the steady-state current conduction is thus reduced, thereby improving the reliability of the switching device.

According to one embodiment of the switching device, the rib extends transversely along a width, the grooves extend transversely along a width, and the width of the rib is between 50% and 100% of the width of the grooves.

According to one embodiment of the switching device, the electric arc guide comprises a second rib lying between a first lateral edge of the arc guide and a first groove.

According to one embodiment of the switching device, the electric arc guide comprises a third rib lying between a second lateral edge of the arc guide and a second groove.

This configuration allows the electric arc to pass through the first rib, then to jump over the groove separating the first rib from the second rib, then to jump again towards the third rib, jumping over the second groove. At a given time, the electric arc is formed between a given rib and the mobile contact. The electric arc does not pass simultaneously through two different ribs. The alternation of ribs and grooves enables greater control of the location of the electric arc. The heat generated in the electric arc guide by the electric arc is thus more effectively controlled, reducing the damage to the electric arc guide.

According to an embodiment of the proposed switching device, one face of the first rib, one face of the second rib and one face of the third rib extend in the same plane.

The common plane of extension of the three ribs is parallel to the axis of rotation of the mobile contact and perpendicular to the main axis of extension of the mobile contact.

The three ribs can have an identical width.

A width of a rib can differ from one rib to another.

According to one aspect of the switching device, the electric arc guide comprises: a first connection area between the rib and a first groove, a second connection area between the rib and the second groove, and a minimum radius of curvature of the profile of the connection areas is less than 0.2 millimeters.

In other words, the connection areas between the rib and the grooves defining this rib are angular and not rounded. These connection areas form sharp edges. The rib is thus clearly defined. The electric arc is thus guided preferentially towards the rib, rather than towards the grooves bordering this rib.

According to one aspect of the switching device, the electric arc guide comprises: a third connection area between the second rib and the first lateral edge of the arc guide, and a minimum radius of curvature of the profile of the third connection area is greater than 0.5 millimeters.

According to one aspect of the switching device, the electric arc guide comprises: a fourth connection area between the third rib and the second lateral edge of the arc guide, and a minimum radius of curvature of the profile of the fourth connection area is greater than 0.5 millimeters.

According to one embodiment of the switching device, the electric arc guide is fixed to the electric conductor of the fixed contact by a screw passing through the electric arc guide.

The arc guide comprises a passage opening for a fixing screw.

The arc guide comprises a passage slot for an anti-rotation pin.

According to one aspect of the switching device, the mobile contact comprises a guide bar configured to allow movement of the first conductor and the second conductor relative to one another. Depending on the operating phases, this movement can be a movement of the first conductor towards the second conductor, or a separation of the first conductor from the second conductor.

The mobile contact comprises an elastic element configured to apply a retraction force tending to bring the first electric conductor and the second electric conductor closer together.

The mobile contact comprises a spacer configured to maintain a minimum distance between the first electric conductor and the second electric conductor.

According to one embodiment of the switching device, in which the electric conductors of the mobile contact are configured to be moved relative to one another in a direction parallel to the axis of rotation, the switching device comprises a mechanical guide rigidly connected to the electric conductor of the fixed contact, the mechanical guide being configured to be in contact with both electric conductors of the mobile contact during part of a movement path from the first position to the second position of the mobile contact, the mechanical guide comprising a tapered profile of decreasing width as the distance from the electric conductor of the fixed contact increases, in order to progressively separate the two electric conductors of the mobile contact from one another when the mobile contact moves from the first position to the second position.

The mechanical guide separates the two electric conductors of the mobile contact before they arrive on the fixed contact, thus facilitating the insertion of the fixed contact between the electric conductors of the mobile contact. Mechanical shocks and friction associated with the insertion of the fixed contact are thus reduced. The mechanical wear of the fixed contact and the mobile contact is thus reduced. The reliability and durability of the switching device are improved. In addition, the insulating nature of the mechanical guide favors the location of the electric arc on the ribs of the arc guide.

The mechanical guide comprises a first support face configured to receive the first electric conductor of the mobile contact and a second support face configured to receive the second electric conductor of the mobile contact, and the distance between the two support faces gradually decreases as the distance from the electric conductor of the fixed contact increases.

The mechanical guide is made of an electrically insulating material.

The mechanical guide is formed from a material having a low coefficient of friction.

The support faces of the mechanical guide have recesses.

According to one embodiment of the switching device, the mechanical guide comprises a housing for receiving part of the electric arc guide.

The mechanical guide can be molded onto the electric arc guide.

The housing for receiving the mechanical guide comprises a base bordered by three lateral faces.

The housing for receiving the mechanical guide can have a shape complementary to a portion of the electric arc guide.

The electric arc guide is arranged between the mechanical guide and the electric conductor of the fixed contact.

The mechanical guide comprises a passage opening for the fixing screw. The mechanical guide has a support surface on which the head of the fixing screw is supported. The support surface of the mechanical guide and the receiving housing extend in parallel planes. The support surface is set back from the edge of the mechanical guide. This recess is greater than the thickness of the head of the screw. The head of the screw is itself therefore set back from the edge of the mechanical guide. In other words, the head of the screw is opposite, in all directions perpendicular to the axis of the screw, to insulating material. This configuration prevents an electric arc from forming between the mobile contact and the head of the screw.

According to one embodiment of the switching device, the electric conductor of the fixed contact comprises a U-shaped curved portion, and the electric arc guide is fixed to the U-shaped curved portion.

The electric conductor of the fixed contact comprises two parallel portions interconnected by a link portion.

The link portion has a semicircular shape.

The fixing screw and the anti-rotation pin extend in a direction parallel to the two parallel portions of the electric conductor of the fixed contact.

The disclosure also describes to a medium-voltage electric unit configured to enable the flow of an electric current in a medium-voltage electric network comprising three phases, the electric unit comprising a switching device as described above, disposed respectively on each phase.

### BRIEF DESCRIPTION OF THE DRAWINGS

Further characteristics, details and advantages will become evident from a reading of the detailed description below and from an analysis of the attached drawings, in which:

FIG. 1 is a schematic representation of an electric unit according to some embodiments;

FIG. 2 is a general perspective view of an electric unit incorporating a switching device according to some embodiments, the switching device being in the open position,

FIG. 3 is a general perspective view of the electric unit shown in FIG. 2, the switching device being in the closed position,

FIG. 4 is a detailed perspective view of an embodiment of the proposed switching device,

FIG. 5 is another detailed perspective view of the switching device shown in FIG. 4,

FIG. 6A and FIG. 6B show detailed views of a fixed contact of the switching device shown in FIGS. 4 and 5,

FIG. 7A and FIG. 7B show further detailed perspective views of elements of the switching device shown in FIGS. 4 and 5,

FIG. 8 is another detailed perspective view of elements of the switching device shown in FIGS. 4 and 5,

FIG. 9 is a detailed side view of an element of the switching device shown in FIGS. 4 and 5,

FIG. 10 is a detailed front view of the switching device shown in FIGS. 4 and 5.

### DETAILED DESCRIPTION

In order to make the figures easier to read, the various elements are not necessarily depicted to scale. In these figures, identical elements bear the same reference signs. Certain elements or parameters can be indexed, that is to say designated for example as the first element or the second element, or indeed the first parameter and the second parameter, etc. The aim of this indexing is to differentiate between elements or parameters which are similar but not identical. This indexing does not imply a priority of one element or parameter with respect to another, and the denominations can be interchanged. When it is specified that a device comprises a given element, this does not exclude the presence of other elements in this device.

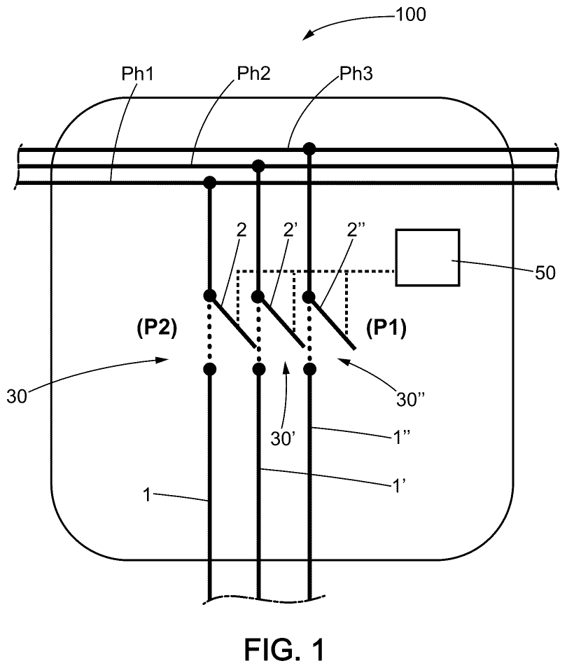

FIG. 1 shows schematically a medium-voltage electric unit 100.

The medium-voltage electric unit 100 is configured to enable the flow of an electric current in a medium-voltage electric network comprising three phases Ph1, Ph2, Ph3.

The electric unit 100 comprises a switching device 30, 30′, 30″ according to some embodiments, arranged respectively on each phase Ph1, Ph2, Ph3.

Each switching device 30, 30′, 30″ comprises a fixed contact 1, 1′, 1″ and a mobile contact 2, 2′, 2″ respectively.

The three switching devices 30, 30′, 30″ are integral with a common actuator 50 enabling simultaneous control of the three switching devices 30, 30′, 30″.

The switching devices 30, 30′, 30″ of the electric unit 100 can be identical.

The proposed switching device 30 is a switching device for a medium-voltage electric unit 100, and will be described in detail below.

The proposed switching device 30 comprises:
a fixed contact 1 comprising an electric conductor 3,
a mobile contact 2 comprising two electric conductors 4A, 4B extending parallel to one another and at a distance from one another.

The mobile contact 2 is configured to pivot with respect to a pivot axis R2 between a first position P1 in which the mobile contact 2 is separated from the fixed contact 1 in order to prevent the flow of an electric current between the contacts 1, 2, and
a second position P2 in which the mobile contact 2 is in contact with the fixed contact 1 in order to allow the flow of electric current between the contacts 1, 2.

The fixed contact 1 comprises an electric arc guide 5 projecting from the electric conductor 3 of the fixed contact 1 and directed towards the mobile contact 2, the electric arc guide 5 being configured to be followed by an electric arc generated upon the establishment of the electric current between the fixed contact 1 and the mobile contact 2,
and the electric arc guide 5 comprises two grooves 6 separated by a rib 7.

An electric arc is generated by bringing two electric contacts 1, 2 placed at different electric potentials close to one another. The generated electric arc passes through the electric arc guide 5, and not directly from one contact to the other. The electric arc guide 5 thus limits the heating of the fixed contact 1 and of the mobile contact 2, and reduces the risk of damage to these contacts. The reliability of the switching device 30 is improved.

A movement of the mobile contact 2 from the first position P1, referred to as the open position, to the second position P2, referred to as the closed position, corresponds to an establishment phase of the electric current in the switching device 30.

Conversely, a movement of the mobile contact 2 from the second position P2, referred to as the closed position, to the first position P1, referred to as the open position, corresponds to a switching phase of the electric current in the switching device 30.

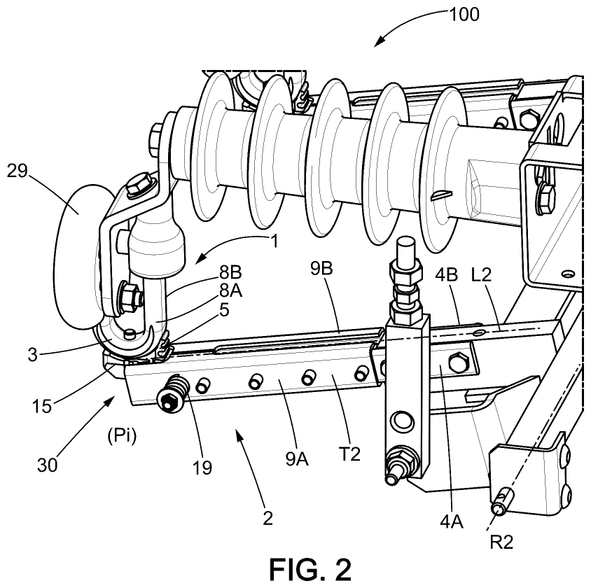

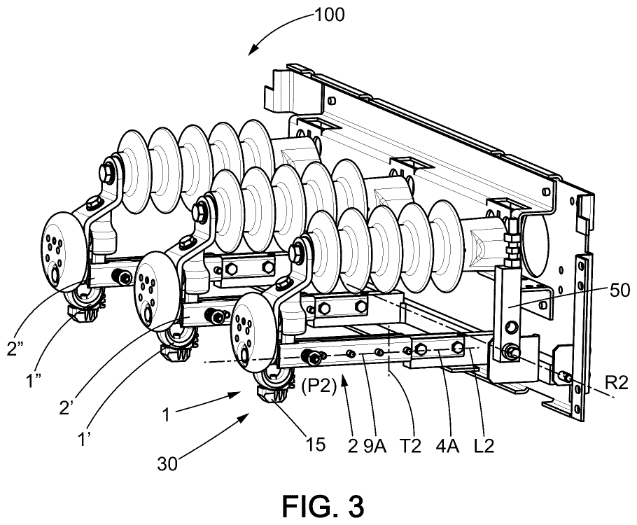

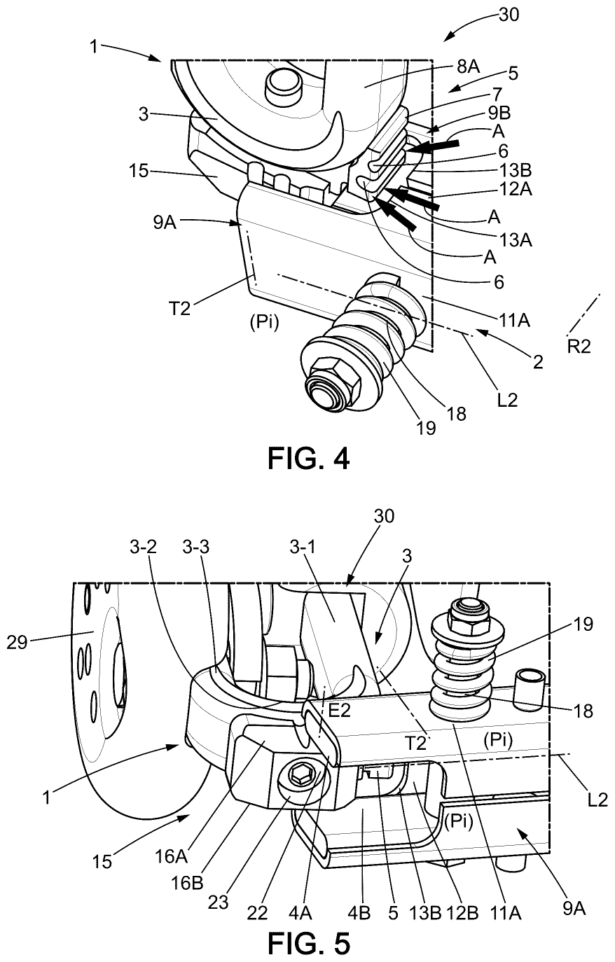

FIG. 3 shows the switching device 30 in the second position P2, referred to as the closed position. FIG. 2, FIGS. 4 and 5 and FIG. 10 show the switching device 30 in an intermediate position Pi between the open position P1 and the second position P2. In FIG. 2, a movement from the first position P1, referred to as the open position, to the second position P2, referred to as the closed position, corresponds to a rotation of the mobile contact 2 with respect to the pivot axis R2 in a clockwise direction.

The two electric conductors 4A, 4B of the mobile contact 2 are connected in rotation about a common axis of rotation R2.

The two electric conductors 4A, 4B of the mobile contact 2 are made of copper.

The two electric conductors 4A, 4B of the mobile contact 2 are commonly referred to as ‘conductor knives’.

Each electric conductor 4A, 4B of the mobile contact 2 has the general shape of a straight bar. The straight bar has a flattened shape.

Each electric conductor 4A, 4B extends in a longitudinal direction, referred to as the main extension direction, corresponding to the length of the electric conductor.

Each electric conductor 4A, 4B extends in a transverse direction perpendicular to the longitudinal direction, corresponding to the width of the electric conductor.

In FIGS. 2 to 4, the direction L2 is parallel to the longitudinal direction of the electric conductors 4A, 4B, and the direction T2 is parallel to the transverse direction of the electric conductors 4A, 4B.

A direction E2 perpendicular to both the longitudinal direction L2 and to the transverse direction T2 corresponds to the thickness of the electric conductors 4A, 4B.

The thickness of each electric conductor is less than 30% of the width of that electric conductor. The width of each electric conductor 4A, 4B is less than 30% of the length of this electric conductor 4A, 4B.

Each electric conductor 4A, 4B comprises two parallel faces. The two faces are parallel to the plane formed by the longitudinal direction L2 and the transverse direction T2. The two faces are thus perpendicular to the pivot axis R2.

Each electric conductor 4A, 4B comprises respectively a first face 4A-i, 4B-i, referred to as the internal face, turned towards the other electric conductor 4B, 4A. In other words, the internal face of one electric conductor 4A, 4B faces the internal face of the other electric conductor 4B, 4A.

Each electric conductor 4A, 4B comprises respectively a second face 4A-e, 4B-e, referred to as the external face, which is the face opposite the internal face.

When the electric current is established, corresponding to a movement from the first position P1 to the second position P2, the electric conductor 3 of the fixed contact 1 is inserted between the two electric conductors 4A, 4B of the mobile contact 2.

When the electric contact is established, the electric conductor 3 of the fixed contact 1 is in mechanical contact with the electric conductor 4A of the mobile contact 2, as well as with the electric conductor 4B of the mobile contact 2.

The electric conductor 3 of the fixed contact 1 is made of copper.

The fixed contact 1 comprises a heat sink 29 fixed to the electric conductor 3. The heat sink 29, itself made of copper, increases the thermal inertia of the fixed contact 1, and therefore reduces its heating.

The electric arc guide 5 is configured to route an electric arc.

In other words, an electric arc generated when the electric current is established passes through the electric arc guide 5. Similarly, an electric arc generated when the electric current is switched passes through the electric arc guide 5.

FIG. 3 shows schematically the passage of an electric arc. Each arrow indicated by the sign A represents a portion of the electric arc.

The electric arc guide 5 is made of extra-hard steel, for example a steel with a carbon content of between 1% and 2%, the content being a mass content.

Alternatively, any other metal having good resistance to high temperatures, significantly greater than that of copper, can be used.

According to the example shown, in particular in FIG. 4, the grooves 6 extend parallel to one another, in a direction parallel to the pivot axis R2 of the mobile contact 2.

The grooves 6 each form a non-opening recess. Two consecutive grooves 6 are separated by a portion of material forming a rib 7.

The mobile contact 2 extends in a main direction L2 perpendicular to the pivot axis R2.

FIG. 9 details the electric arc guide 5 taken in isolation, in a profile view.

The depth p6 of a groove 6 can be greater than the width 17 of the rib 7.

The depth p6 of a groove can vary from one groove to another.

According to the example shown, a base of the grooves 6 has a semicircular profile.

The grooves 6 are, for example, obtained by machining. The shape of the base of the grooves is then the shape complementary to that of the milling cutter used to form the grooves.

Alternatively, the grooves 6 can be obtained by molding. In this case, the shape of the grooves 6 corresponds to the shape complementary to that of the counterpart formed in the mold.

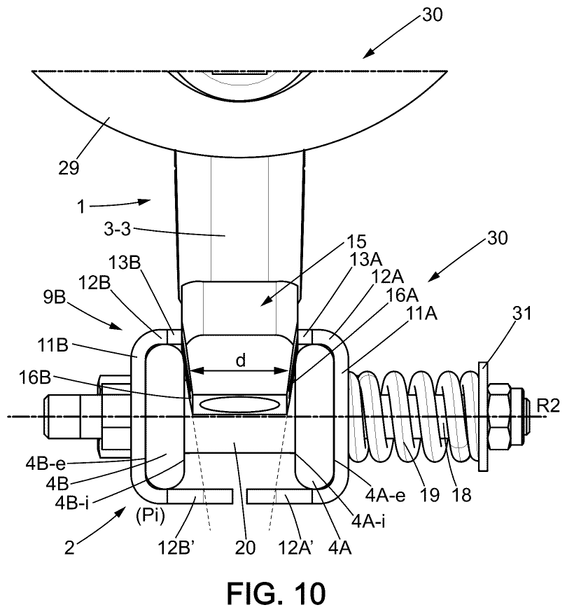

According to the example shown, and as shown in FIG. 4, FIG. 5 and FIG. 10, the mobile contact 2 comprises a first reinforcement element 9A.

The first reinforcement element 9A comprises a first portion 11A supported on the first electric conductor 4A of the mobile contact 2 and a second portion 12A extending perpendicular to the first portion 11A in the direction of the second electric conductor 4B of the mobile contact 2.

A lateral edge 13A of the second portion 12A of the first reinforcement element 9A extends parallel to the axis of rotation R2 of the mobile contact 2.

As shown schematically in FIG. 4, an electric arc generated by the establishment of the electric current between the fixed contact 1 and the mobile contact 2 passes from the lateral edge 13A of the first reinforcement element 9A to the rib of the electric arc guide 5.

The lateral edge 13A of the second portion 12A of the first reinforcement element 9A is at a distance from the end of the electric conductor 4A opposite the axis of rotation R2.

The lateral edge 13A of the second portion 12A of the first reinforcement element 9A is set back from the end of the mobile contact 2 located opposite the axis of rotation R2, in order to allow the passage of the mobile contact 2 without touching the electric arc guide 5 during the rotation of the mobile contact 2.

The first reinforcement element 9A comprises, for example, a plate.

The first reinforcement element 9A is made of metal.

The first reinforcement plate 9A is formed of a folded metal strip.

The first reinforcement plate 9A is, for example, made of steel.

The first reinforcement plate 9A has a U-shaped profile. The first portion 11A of the first reinforcement element 9A forms the base of the U-shaped profile.

The base of the U-shaped profile bears on the outer lateral face 4A-e of the first electric conductor 4A of the contact mobile 2.

The second portion 12A forms a first wing of the U-shaped profile. A third portion 12A′ forms a second wing of the U-shaped profile. The second portion 12A and the third portion 12A′ extend in parallel planes.

The lateral edge 13A of the second portion 12A of the first reinforcement element 9A is successively opposite a first groove 6, the rib 7, and then a second groove 6 when the mobile contact 2 moves from the first position P1 to the second position P2.

During this rotational movement from the first position P1 to the second position P2, each point of the lateral edge 13A of the second portion 12A of the first reinforcement element 9A describes a trajectory in the form of a circular arc, the center of this circular arc being located on the pivot axis R2.

The minimum distance between the rib 7 and the lateral edge 13A of the second portion 12A of the first reinforcement element 9A is less than 3.0 millimeters.

This minimum distance is obtained for a given angular position of the mobile contact 2. This minimum distance enables the initiation of the electric arc in a controlled manner between the mobile contact 2 and the electric arc guide 5. At least part of the electric arc passes through the lateral edge 13A of the second portion 12A of the first reinforcement element 9A.

Similarly, the mobile contact 2 comprises a second reinforcement element 9B.

The second reinforcement element 9B comprises a first portion 11B supported on the second electric conductor 4B of the mobile contact 2 and a second portion 12B extending perpendicular to the first portion 11B in the direction of the first electric conductor 4A of the mobile contact 2.

A lateral edge 13B of the second portion 12B of the second reinforcement element 9B extends parallel to the axis of rotation R2 of the mobile contact 2.

According to the example shown, particularly in FIG. 4, the lateral edge 13A of the second portion 12A of the first reinforcement element 9A and the lateral edge 13B of the second portion 12B of the second reinforcement element 9B extend in line with one another.

The second reinforcement element 9B comprises, for example, a plate.

The first reinforcement plate 9A and the second reinforcement plate 9B are symmetrical to one another with respect to a plane perpendicular to the pivot axis R2.

The first reinforcement plate 9A and the second reinforcement plate 9B are the mirror image of one another.

The second reinforcement plate 9B thus has a U-shaped profile. The base of the U is supported on the external lateral face 4B-e of the second electric conductor 4B of the mobile contact 2.

The second portion 12B forms a first wing of the U-shaped profile, and a third portion 12A′ forms a second wing of the U-shaped profile

The lateral edge 13B of the second portion 12B of the second reinforcement element 9B is successively opposite the first groove 6, the rib 7, then the second groove 6 when the mobile contact 2 moves from the first position P1 to the second position P2.

A minimum distance between the rib 7 and the lateral edge 13B of the second portion 12B of the second reinforcement element 9B is less than 3.0 millimeters.

As with the first reinforcement element 9A, this minimum distance enables the initiation of the electric arc in a controlled manner between the mobile contact 2 and the electric arc guide 5. At least part of the electric arc passes through the lateral edge 13B of the second portion 12B of the second reinforcement element 9B.

The electric conductor 3 of the fixed contact 1 comprises two contact portions 8A, 8B in mechanical contact with the mobile contact 2 when the mobile contact 2 is in the second position P2, referred to as the closed position, and the electric arc guide 5 is at a distance from the two contact portions 8A, 8B.

In other words, the two contact portions 8A, 8B in mechanical contact with the mobile contact 2 when the mobile contact 2 is in the second position P2 are separated from the electric arc guide 5.

These two contact portions 8A, 8B are the portions through which the electric current passes with the current flow in a steady state.

The heating generated by the passage of the electric arc thus takes place in a part of the fixed contact 1 which differs from the portions 8A, 8B through which the electric current passes in a steady state. The damage to the areas 8A, 8B of the fixed contact 1 participating in the current conduction in a steady state is thus reduced, which improves the reliability of the switching device 30.

The two contact portions 8A, 8B of the electric conductor 3 can be seen in FIG. 2, in which the mobile contact 2 is in a position which differs from the closed position P2.

The two contact portions 8A, 8B are not visible in FIG. 3, because they are masked by the mobile contact 2.

According to one embodiment of the switching device 30, the rib 7 extends transversely along a width 17, the grooves 6 extend transversely along a width 16, and the width 17 of the rib 7 is between 50% and 100% of the width 16 of the grooves 6.

The transverse extension direction of the rib 7 and of the grooves 6 is a direction perpendicular to both the pivot axis R2 and the main extension direction L2 of the mobile contact 2.

The longitudinal extension direction of the rib 7 and of the grooves 6 is a direction parallel to the pivot axis R2.

According to the example shown, and as shown in FIG. 9, the electric arc guide 5 comprises a second rib, denoted 7-2, lying between a first lateral edge 10-1 of the arc guide 5 and a first groove, denoted 6-1.

The electric arc guide 5 also comprises a third rib, denoted 7-3, between a second lateral edge 10-2 of the arc guide 5 and a second groove, denoted 6-2.

This configuration allows the electric arc, during the movement allowing the establishment of the electric current, to pass through the second rib 7-2, then to jump the groove 6-1 separating the second rib 7-2 from the first rib 7, then to jump again towards the third rib 7-3, by jumping over the second groove 6-2.

At a given time, the electric arc is formed between a given rib and the mobile contact 2. The electric arc does not pass simultaneously through two different ribs. The alternation of ribs and grooves enables better control of the location of the electric arc. The dissipation of the heat generated in the arc guide 5 by the electric arc is thus better controlled, thereby reducing the damage to the electric arc guide 5.

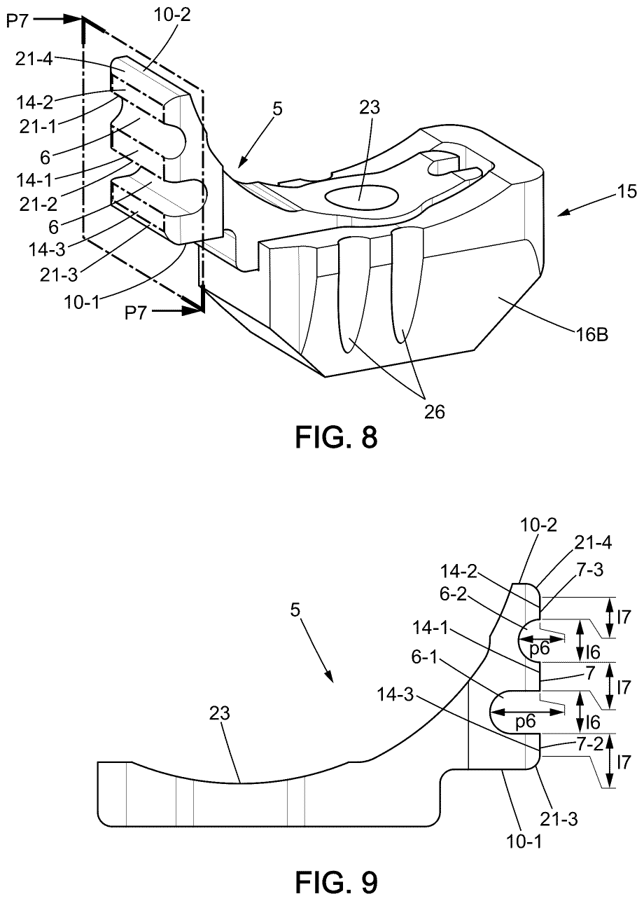

According to the example shown, and as shown in FIG. 8, a face 14-1 of the first rib, a face 14-2 of the second rib and a face 14-3 of the third rib extend in the same plane P7.

The common extension plane P7 of the three ribs is parallel to the axis of rotation R2 of the mobile contact 2 and perpendicular to the main extension axis L2 of the mobile contact 2.

The three ribs 7 can have an identical width 17.

The width 17 of a rib can differ from one rib to another.

The electric arc guide 5 comprises:
a first connection area 21-1 between the rib 7 and a first groove 6,
a second connection area 21-2 between the rib 7 and the second groove 6,
and a minimum radius of curvature of the profile of the connection areas 21-1, 21-2 is less than 0.2 millimeters.

In other words, the connection areas 21-1, 21-2 between the rib 7 and the grooves 6 defining this rib 7 are angular and not rounded. These connection areas 21-1, 21-2 form sharp edges. The rib 7 is thus clearly defined. The electric arc is thus guided preferentially towards the rib 7, rather than towards the grooves 6 bordering this rib 7. The position of the electric arc is thus better controlled.

The electric arc guide 5 comprises:
a third connection area 21-3 between the second rib 7 and the first lateral edge 10-1 of the arc guide 5,
and a minimum radius of curvature of the profile of the third connection area 21-3 is greater than 0.5 millimeter.

Similarly, the electric arc guide 5 comprises:
a fourth connection area 21-4 between the third rib 7 and the second lateral edge 10-2 of the arc guide 5,
and a minimum radius of curvature of the profile of the fourth connection area 21-4 is greater than 0.5 millimeter.

The areas defining the outer edges of the electric arc guide 5 are thus rounded in order to avoid any risk of injury when the electric arc guide is mounted on the electric conductor 3 of the fixed contact 1.

In the example shown, the electric conductor 3 of the fixed contact 1 comprises a portion 3-2 curved into a U-shape,
and the electric arc guide 5 is fixed to the portion 3-2 curved into a U-shape

The electric conductor 3 of the fixed contact 1 comprises two parallel portions 3-1, 3-3 interconnected by a connecting portion 3-2.

The connecting portion 3-2 has a semicircular shape.

The electric arc guide 5 is fixed to the electric conductor 3 of the fixed contact 1 by a screw 22 passing through the electric arc guide 5.

The electric arc guide 5 comprises a passage opening 23 for a fixing screw 22.

According to the embodiment shown, the electric arc guide 5 comprises a slot 25 for the passage of an anti-rotation pin 24.

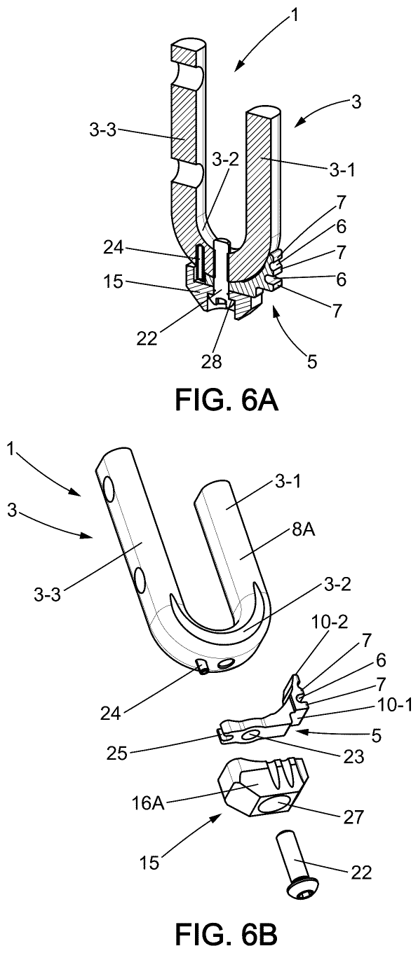

The fixing screw 22 and the anti-rotation pin 24, visible more particularly in FIG. 6A and FIG. 6B, extend parallel to one another.

One end of the anti-rotation pin 24 is disposed in an opening of complementary shape arranged in the electric conductor 3 of the fixed contact 1. The opposite end of the anti-rotation pin 24 projects from the electric conductor 3.

The fixing screw 22 and the anti-rotation pin 24 extend in a direction parallel to the two parallel portions 3-1, 3-3 of the electric conductor 3 of the fixed contact 1.

As shown particularly in FIG. 4, FIG. 5 and FIG. 10, the mobile contact 2 comprises a guide bar 18 configured to allow the first conductor 4A and the second conductor 4B to move relative to one another.

Depending on the operating phases, this movement can bring the first conductor 4A and the second conductor 4B closer together, or can separate the first conductor 4A and the second conductor 4B from one another.

The mobile contact 2 comprises an elastic element 19 configured to apply a retraction force tending to bring the first electric conductor 4A and the second electric conductor 4B closer together.

The elastic element 19 here is a coil spring.

A first end of the spring 19 is supported on a washer 31 secured to the guide bar 18. The second end of the spring 19 is supported on the first portion 11A of the first reinforcement element 9A.

A shoulder of the guide bar 18 is supported on the first portion 11B of the second reinforcement element 9B.

The mobile contact 2 comprises a spacer 20 configured to maintain a minimum distance between the first electric conductor 4A and the second electric conductor 4B.

The spacer 20 is disposed between the first electric conductor 4A and the second electric conductor 4B.

The spacer is coaxial with the guide bar 18.

The spacer 20 is in the form of a tube in the middle of which the guide bar 18 passes respectively.

The axial surfaces of the spacer 20 respectively form an abutment surface against which the electric conductors 4A, 4B of the mobile contact 2 are supported when the fixed contact 1 is separated from the mobile contact 2.

When the fixed contact 1 is not in contact with the electric conductors 4A, 4B, the spring 19 presses the electric conductor 4A against a first axial surface of the spacer 20, and presses the electric conductor 4B against a second axial surface of the spacer 20.

In addition to the electric arc guide 5, the switching device 30 can comprise a mechanical guide 15 facilitating the movement of the conductor knives 4A, 4B relative to one another during the electric current establishment phase.

Thus, according to the example shown, in which the electric conductors 4A, 4B of the mobile contact 2 are configured to be moved relative to one another in a direction parallel to the axis of rotation R2, the switching device 30 comprises a mechanical guide 15 rigidly connected to the electric conductor 3 of the fixed contact 1. The mechanical guide 15 is configured to be in contact with the two electric conductors 4A, 4B of the mobile contact 2 during a part of a movement from the first position P1 to the second position P2 of the mobile contact 2L. The mechanical guide 15 has a tapered profile, its width decreasing as the distance from the electric conductor 3 of the fixed contact 1 increases, such that the two electric conductors 4A, 4B of the mobile contact 2 are progressively separated from one another when the mobile contact 2 moves from the first position P1 to the second position P2.

The mechanical guide 15 separates the two electric conductors 4A, 4B of the mobile contact 2 from one another before they arrive at the fixed contact 1. The distance separating two electric conductors 4A, 4B thus increases progressively before and during the phase of establishing mechanical contact between the electric conductors 4A, 4B of the mobile contact 2 and the electric conductor 3 of the fixed contact 1. The insertion of the fixed contact 1 between the electric conductors 4A, 4B of the mobile contact 2 is thus facilitated. The mechanical shocks and friction associated with the insertion of the fixed contact 1 are thus reduced. The mechanical wear of the fixed contact 1 and of the mobile contact 2 is thus reduced. The reliability and longevity of the switching device 30 are improved.

Moreover, the insulating nature of the mechanical guide 15 favors the location of the electric arc on the ribs 6 of the arc guide 5.

The mechanical guide 15 has a tapered profile, the thickest part of the profile being on the side of the electric conductor 3 of the fixed contact 1, and the thinnest part being on the opposite side, i.e. the side closest to the mobile contact 2 when the latter is in the open position P1.

The mechanical guide 15 comprises a first support face 16A configured to receive the first electric conductor 4A of the mobile contact 2 and a second support face 16B configured to receive the second electric conductor 4B of the mobile contact 2.

The distance d between the two support faces 16A, 16B decreases progressively as the distance D from the electric conductor 3 of the fixed contact 1 increases.

The mechanical guide 15 has the general shape of a parallelepiped, two opposite faces 16A, 16B of which are non-parallel. The mechanical guide 15 is located between the electric conductor 3 of the fixed contact 1 and a virtual intersection line between the first support face 16A and the second support face 16B.

The mechanical guide 15 is made of an electrically insulating material.

The mechanical guide 15 is formed from a material having a low coefficient of friction.

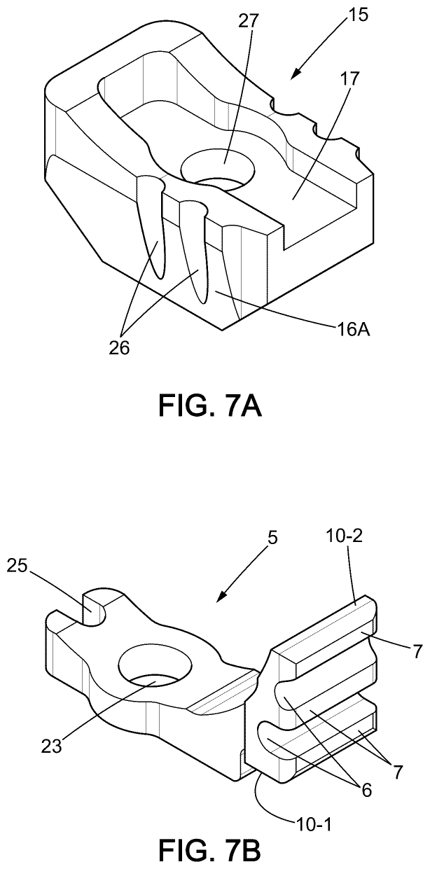

The support faces 16A, 16B of the mechanical guide 15 comprise recesses 26, more particularly visible in FIG. 7A.

According to the example shown, the mechanical guide 15 comprises a housing 17 for receiving part of the electric arc guide 5.

The housing 17 for receiving the mechanical guide 15 comprises a base bordered by three lateral faces.

FIG. 7A shows the mechanical guide 15, and FIG. 7B shows the electric arc guide 5, the two elements being separated.

Here, the housing 17 for receiving the mechanical guide 15 has a shape complementary to a portion of the electric arc guide 5.

According to one embodiment (not shown), the mechanical guide 15 can be molded onto the electric arc guide 5.

In this case, the mechanical guide 15 and the electric arc guide 5 form a non-detachable sub-assembly.

Part B shows an exploded view of the main elements of the fixed contact 1. Part B shows a sectional view of the same assembled elements.

The electric arc guide 5 is disposed between the mechanical guide 15 and the electric conductor 3 of the fixed contact 1.

The fixing screw 22 passes successively through the mechanical guide 15 and the electric arc guide 5.

The mechanical guide 15 comprises a passage opening 27 for the fixing screw 22.

The mechanical guide 15 comprises a support surface 28 on which the head of the fixing screw 22 is supported.

The passage opening 27 formed in the mechanical guide 15 is aligned with the passage opening 23 formed in the electric arc guide 5.

The support surface 28 of the mechanical guide 15 and the receiving housing 17 extend in parallel planes.

The support surface 28 is set back from the edge of the mechanical guide 15.

This setback is greater than the thickness of the head of the screw 22. The head of the screw 22 is therefore itself set back from the edge of the mechanical guide 15. In other words, the head of the screw 22, in all directions perpendicular to the axis of the screw 22, lies opposite electrically insulating material. This configuration prevents the formation of an electric arc between the mobile contact 2 and the head of the screw 22.

The presence of the mechanical guide 15 on the switching device 30 is optional.

According to the example shown here, the switching device 30 comprises an electric arc guide 5 and a mechanical guide 15.

According to one embodiment (not shown), the switching device 30 comprises a mechanical guide 15 but is not equipped with an electric arc guide.

In this case, a switching device 30 is proposed for a medium-voltage electric unit 100, the switching device 30 having:
a fixed contact 1 comprising an electric conductor 3,
a mobile contact 2 comprising two electric conductors 4A, 4B extending parallel to and at a distance from one another,
the mobile contact 2 being configured to pivot about a pivot axis R2 between:
a first position P1 in which the mobile contact 2 is separated from the fixed contact 1 in order to prevent the flow of electric current between the contacts 1, 2, and
a second position P2 in which the mobile contact 2 is in contact with the fixed contact 1 in order to allow the flow of electric current between the contacts 1, 2,
wherein the electric conductors 4A, 4B of the mobile contact 2 are configured to be moved relative to one another in a direction parallel to the axis of rotation R2,
and wherein the switching device 30 comprises a mechanical guide 15 rigidly connected to the electric conductor 3 of the fixed contact 1, the mechanical guide 15 being configured to be in contact with the two electric conductors 4A, 4B of the mobile contact 2 during a part of a movement from the first position P1 to the second position P2 of the mobile contact 2, the mechanical guide 15 comprising a tapered profile of decreasing width as the distance from the electric conductor 3 of the fixed contact 1 increases, in order to progressively separate the two electric conductors 4A, 4B of the mobile contact 2 from one another during a movement from the first position P1 to the second position P2 of the mobile contact 2.

1. A switching device for a medium-voltage electric unit, the switching device having:
a fixed contact comprising an electric conductor,
a mobile contact comprising two electric conductors extending parallel to and at a distance from one another,
the mobile contact being configured to pivot about a pivot axis between:
a first position in which the mobile contact is separated from the fixed contact in order to prevent electric current flow between the contacts, and
a second position in which the mobile contact is in contact with the fixed contact in order to allow electric current to flow between the contacts,
wherein the fixed contact comprises an electric arc guide projecting from the electric conductor of the fixed contact and directed towards the mobile contact, the electric arc guide being configured to be followed by an electric arc generated upon the establishment of the electric current between the fixed contact and the mobile contact,
wherein the electric arc guide comprises two grooves separated by a rib.

2. The switching device according to claim 1, wherein the grooves extend parallel to one another in a direction parallel to the pivot axis of the mobile contact, and wherein the mobile contact extends in a main direction perpendicular to the pivot axis.

3. The switching device according to claim 1, wherein the mobile contact comprises a first reinforcement element,
the first reinforcement element comprising a first portion supported on the first electric conductor of the mobile contact, and a second portion extending perpendicular to the first portion in the direction of the second electric conductor of the mobile contact,
wherein a lateral edge of the second portion of the first reinforcement element extends parallel to the axis of rotation of the mobile contact.

4. The switching device according to claim 3, wherein the mobile contact comprises a second reinforcement element,
the second reinforcement element comprising a first portion supported on the second electric conductor of the mobile contact and a second portion extending perpendicular to the first portion in the direction of the first electric conductor of the mobile contact,
wherein a lateral edge of the second portion of the second reinforcement element extends parallel to the axis of rotation of the mobile contact.

5. The switching device according to claim 1, wherein the electric conductor of the fixed contact comprises two contact portions in mechanical contact with the mobile contact when the mobile contact is in the second position, referred to as the closed position, and in which the electric arc guide is at a distance from the two contact portions.

6. The switching device according to claim 1, wherein the rib extends transversely according to a width, wherein the grooves extend transversely through a width, and in which the width of the rib is between 50% and 100% of the width of the grooves.

7. The switching device according to claim 1, wherein the electric arc guide comprises:
a second rib between a first lateral edge of the arc guide and a first groove, and
a third rib between a second lateral edge of the arc guide and a second groove.

8. The switching device according to claim 1,
wherein the electric conductors of the mobile contact are configured to be moved relative to one another in a direction parallel to the axis of rotation,
and wherein the switching device comprises a mechanical guide rigidly connected to the electric conductor of the fixed contact, the mechanical guide being configured to be in contact with the two electric conductors of the mobile contact during a part of a movement from the first position to the second position of the mobile contact, the mechanical guide comprising a tapered profile of decreasing width as the distance from the electric conductor of the fixed contact increases, in order to progressively separate the two electric conductors of the mobile contact from one another when the mobile contact moves from the first position to the second position.

9. The switching device according to claim 8, wherein the mechanical guide has a first support face configured to receive the first electric conductor of the mobile contact and a second support face configured to receive the second electric conductor of the mobile contact,
and wherein the distance between the two support faces gradually decreases as the distance from the electric conductor of the fixed contact increases.

10. The switching device as claimed in claim 8, wherein the mechanical guide comprises a housing for receiving a part of the electric arc guide,
and wherein the electric arc guide is arranged between the mechanical guide and the electric conductor of the fixed contact.

11. The switching device according to claim 1, wherein the electric conductor of the fixed contact comprises a U-shaped curved portion, and wherein the electric arc guide is attached to the U-shaped curved portion.

12. A medium-voltage electric unit configured to enable the flow of an electric current in a medium-voltage electric network comprising three phases, the electric unit comprising a switching device according to claim 1, arranged respectively on each phase.
